(19) United States
(12) Patent Application Publication
(10) Pub. No.: US 2010/0180278 A1
(43) Pub. Date: Jul. 15, 2010

(54) Resource management apparatus and computer program product

(75) Inventors: Hideki Yoshida, Tokyo (JP); Nobuo Sakiyama, Kanagawa (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/585,055

(22) Filed: Sep. 1, 2009

(30) Foreign Application Priority Data
Jan. 13, 2009 (JP) 2009-004989

(51) Int. Cl. G06F 9/50

(52) U.S. Cl. 718/103; 718/104

(57) ABSTRACT

Provided is a resource management apparatus for determining allocation of a resource to be consumed or supplied by each of a plurality of applications within a predetermined unit time in a bidding process. The resource management apparatus includes a bid value calculating unit configured to calculate a bid value representing a hypothetical price of the resource, a CPU price adjusting unit configured to adjust the bid value supplied by an application, which has a smaller resource consumption amount than another application, to be greater than the bid value of the another application, and a bid managing unit configured to allocate the resource to each of the plurality of applications taking the adjusted bid value into account.

### CROSS-REFERENCE TO RELATED APPLICATIONS

This application is based upon and claims the benefit of priority from the prior Japanese Patent Application No. 2009-004989, filed on Jan. 13, 2009; the entire contents of which are incorporated herein by reference.

### BACKGROUND OF THE INVENTION

1. Field of the Invention

The present invention relates to an apparatus and a program for managing resources that are consumed or supplied by each of application programs within a predetermined unit time.

2. Description of the Related Art

So-called real-time systems with sensors have been widely used. For example, in the field of transport machines such as ships, airplanes and cars, sensor information systems are used to keep track of surrounding circumstances and present information on the circumstances to users through screen display or the like. A sensor information system for a ship has a plurality of sensors such as a radar, a sonar, an infrared sensor, and a camera. The sensor information system analyzes signals of one or more sensors depending on each situation to recognize the surrounding circumstances, and displays the recognition results on a screen or the like. The information on the surrounding circumstances is useful for safe navigation of ships.

In the systems in the transportation field, the screen display must be updated within a predetermined time in order to inform the user of the information on the recognized surrounding circumstances. If the user cannot instantly keep track of the surrounding circumstances, an accident such as a collision may be caused. Therefore, the systems must be real-time systems and signal processing of sensor signals is required to be performed as real-time processing that satisfies a predetermined time constraint.

In such a real-time system that processes a plurality of sensor signals, it has been a common practice to process the signals in independent subsystems. Computer resources such as a central processing unit (CPU) necessary to process each sensor signal are separately provided for each subsystem, one real-time operating system (OS) is operated for each subsystem, whereby allocating resources on each subsystem. As a result, the design and development of a sensor information system that satisfies a predetermined time constraint are facilitated.

However, there are problems in the method of separately providing an independent subsystem for each signal. When an overload occurs in one subsystem that covers a certain signal or a failure occurs in a component of a subsystem, the subsystem cannot satisfy the predetermined time constraint in processing the signal or the subsystem cannot perform processing at all, even if another subsystem has a margin in its computer resources.

Thus, up to now, each subsystem needs to be configured such that a predetermined margin in function and processing capacity is ensured in order that each subsystem itself can cope with an overload or a failure. However, such a subsystem configured to have a margin requires excessive hardware equipment, thus increasing the cost, the volume, and power consumption of the equipment. This degrades the commercial and technical feasibility of the sensor information system.

Thus, there is a demand in the field of airplanes to construct a sensor information system with relatively less hardware equipment by integrating signal processing of a plurality of signals into one computer system. In general, such a system is implemented as a distributed system that includes a plurality of nodes having one or more processors, a memory, and input/output units, and a network that connects the nodes.

However, there is a problem in the method of simply integrating signal processing of a plurality of signals into one system. When a more important signal and a less important signal are present in processing a plurality of signals, an increase in the process load of the less important signal may adversely affect on the process time constraint of the more important signal.

In theory, this problem can be overcome by operating one real-time OS on the entire system and entirely performing a real-time scheduling operation. In reality, however, when a system that includes a plurality of processors is managed by a single OS, a scheduling operation becomes complicated and the scheduling process requires a long time, thus making it difficult to achieve the performance satisfying time constraints. In addition, as even more serious problem, if nodes are connected through a network not guaranteeing the strict real-time characteristics, it is impossible to perform a real-time scheduling operation across the nodes.

Researches have been conducted on a method of bid-based resource allocation as a method of performing resource allocation in a distributed system in a distributed manner (see Andrew Byde, Mathias Salle, and Claudio Bartolini, Market-Based Resource Allocation for Utility Data Centers, HP Labs Technical Report HPL-2003-188, 2003, for example).

The bid-based resource allocation method allocates resources, such as a CPU time, using a bidding process for each unit time or for each task. That is, each application program (hereinafter, also simply referred to as “application”) sets a price and requests resource allocation, and an application presenting the highest price is allocated the resource for operation. The currency used in the bidding process is an indicator for qualifying the degree of importance of an application to a user and is a virtual currency that need not be linked to an actual currency. This method has a characteristics that each module in the system behaves to maximize the profit, i.e., the difference between the received currency and the paid currency, thereby improving the total system efficiency.

Using this bidding method, the allocation of resources depending on the importance of signals in each situation can be implemented by allowing an application that is processing an important sensor signal to have a high bid price. In addition, because a bid process can be performed in a distributed manner by performing a bid process for each node, it is easy to perform the resource allocation in a distributed manner.

In a simple resource allocation model, only physical resources, such as a CPU time, are resources, OS and middleware programs are suppliers of resources, and application programs are consumers. In an actual system, a more advanced bid is sometimes performed based on a more complicated resource allocation model.

A more advanced resource allocation model, which is called a supply chain model, is sometimes used for a bid-based resource allocation in a distributed system (see William E. Walsh and Michael P. Wellman, Efficiency and Equilibrium in Task Allocation Economies with Hierarchical Dependencies, in Proceedings of the Sixteenth International Joint Conference on Artificial Intelligence, 1999, for example).

This model is modeled after a supply chain model in the manufacture/distribution industries. In this model, the concept of a “producer” is introduced in addition to a supplier and a consumer. The producer purchases resources from other parties and produces resources to be sold to other parties. In addition to physical resources, data produced by the producer is also handled as a resource.

By introducing the concept of a producer, the distribution of processes to a plurality of nodes and the control of an application that pre-processes data used by another application can be handled in a bidding model. It should be noted that a supplier, a consumer, and a producer mean module programs implemented by a software in each system and do not mean any natural person or legal person.

In the bidding method using the supply chain model, how to determine a bid price is generally complicated as compared with the simple model mentioned above (see William E. Walsh and Michael P. Wellman, Efficiency and Equilibrium in Task Allocation Economies with Hierarchical Dependencies, in Proceedings of the Sixteenth International Joint Conference on Artificial Intelligence, 1999, for example). For example, in determining a sale price of a resource by a producer, it is necessary to consider a possible purchase price of resources required to produce the resource to be sold. Also, it is necessary to cancel bidding if the sale price is lower than the purchase price. A complicated calculation expression may be used to determine a bid price at a time, but this requires an increased amount of calculations. Therefore, it is a common practice to repeat bidding a plurality of rounds using a temporary price until the price is settled.

An example of a producer's bidding policy (how to determine the bid price) in the multi-round bidding method is as follows. Initially, both a resource to be sold and a resource to be purchased are bid at appropriate initial prices. Then, a sale price and a purchase price are changed slightly depending on whether the resource to be sold and the resource to be purchased are successfully bidden, but if there is no profit (i.e., the sale price is lower than the purchase price), the bid is abandoned. By repeating such rounds, the bid price is determined when the sale price and the purchase price are increased to an appropriate level, or the bid is abandoned.

The bidding method for a supply chain bid is described above. Not limited to the supply chain bid, the multi-round bidding is often performed in complicated bidding cases, such as a multiple bid in which a plurality of resources are allocated simultaneously or concurrently.

When the resource allocation using the multi-round bidding is performed by a real-time system, a method of discontinuing bidding by restricting the number of rounds or by restricting the time is used to satisfy the time constraints (see JP-A 2008-004046 (KOKAI), for example).

In the above bidding method for allocating resources, a successful bidder is simply determined only by a price. Therefore, when sale prices of producers participating in a bid with a small amount of data are low, data of many producers can be successful bidden in a subdivided manner, thus allocating processes to many nodes in a subdivided manner.

For example, when a system includes three nodes each executing three producer applications, each of the processes of three applications may be distributed to three nodes, resulting in that a total of nine producers are all operated.

Such an unnecessary distribution causes the following overheads. An increase in the number of processes running in each node increases the usage of a memory, a CPU cache, and a disk cache. Also, the usage of the CPU and memory by a consumer that is in communication with producers increases due to an increase in the number of communication sessions caused by an increase in the number of communication target nodes. These overheads degrade the execution speed of an application.

If a process can be completed by one node, the above-mentioned degradation in performance can be better prevented by allocating the process to one node instead of distributing the process to a plurality of nodes in a subdivided manner.

If an allocation such that the first node is allocated only an application 1, the second node is allocated only an application 2, and the third node is allocated only an application 3 is possible in the example above, then a total of only three producers are operated, thus preventing the performance degradation caused by an unnecessary distribution.

### SUMMARY OF THE INVENTION

According to an aspect of the invention, a resource management apparatus for determining allocation of a resource to be consumed or supplied by each of a plurality of applications within a predetermined unit time in a bidding process, includes a bid value calculating unit configured to calculate a bid value representing a hypothetical price of the resource; an adjusting unit configured to adjust the bid value supplied by an application, which has a smaller resource consumption amount than another application, to be greater than the bid value of the another application; and a bid managing unit configured to allocate the resource to each of the plurality of applications taking the adjusted bid value into account.

According to another aspect of the invention, a computer program product has a computer-readable medium stored thereon instructions for managing a resource in a bidding process that allocates the resource to be consumed or supplied by each of a plurality of applications within a predetermined unit time, and the instructions, when executed by a computer, causes the computer to calculate a bid value representing a hypothetical price of the resource; adjust the bid value supplied by an application, which has a smaller resource consumption amount than another application, to be greater than the bid value of the another application; and allocate the resource to each of the plurality of applications taking the adjusted bid value into account.

### BRIEF DESCRIPTION OF THE DRAWINGS

FIG. 1 is a block diagram illustrating a hardware configuration of a sensor information system according to an exemplary embodiment of the present invention;

FIG. 2 is a block diagram illustrating a resource management part of a software configuration according to the embodiment;

FIG. 3 is a block diagram illustrating the relationship between supply and consumption of resources according to the embodiment;

FIG. 4 is a block diagram illustrating configurations of a resource bidding unit and a bid managing unit;

FIG. 5 is a flow chart illustrating an example of a processing flow of a bid value calculating unit of a supplier;

FIG. 6 is a flow chart illustrating an example of a processing flow of a bid value calculating unit of a producer;

FIG. 7 is a flow chart illustrating an example of a processing flow of a CPU price adjusting unit;

FIG. 8 is a flow chart illustrating an example of a processing flow of a bid value calculating unit of a consumer;

FIG. 9 is a diagram explaining that a bidding process is performed only a predetermined number of times;

FIG. 10 is a diagram explaining a process unit time;

FIG. 11 is a table illustrating an example of the bid information of physical resources;

FIG. 12 is a diagram illustrating an example of the bid information of data;

FIG. 13 is a flow chart illustrating an example of a processing flow of a successful bidder determining unit of a physical resource manager;

FIG. 14 is a flow chart illustrating an example of a processing flow of a successful bidder determining unit of an information displaying application;

FIG. 15 is a flow chart illustrating an example of a processing flow of a round repetition managing unit;

FIG. 16 is a table illustrating an example of a change in the amount and value of a bid and a successful bid of a CPU usage rate with the lapse of round; and

FIG. 17 is a table illustrating an example of a change in the amount and value of a bid and a successful bid of data with the lapse of round.

### DETAILED DESCRIPTION OF THE INVENTION

Hereinafter, a resource management apparatus and programs according to an exemplary embodiment of the present invention will be described in detail with reference to the accompanying drawings.

1. Hardware Configuration of System

A sensor information processing system (hereinafter, referred to as “sensor information system”) according to the embodiment is used in ships, airplanes, or the like. The sensor information system is a system that notifies surrounding situations as sensor information to crew members based on sensor signals received from radar devices and sonar devices. The sensor information system is a so-called real-time system that senses a dangerous obstacle or the like and notifies the sensor information to crew members quickly, that is, within a predetermined time since the dangerous obstacle is sensed, through a display screen or the like. Incidentally, a “real-time system” is a system that executes a predetermined process within a predetermined time, for example, senses a sensor signal and displays sensor information on a screen of a display device within 1 second since the sensor signal is sensed.

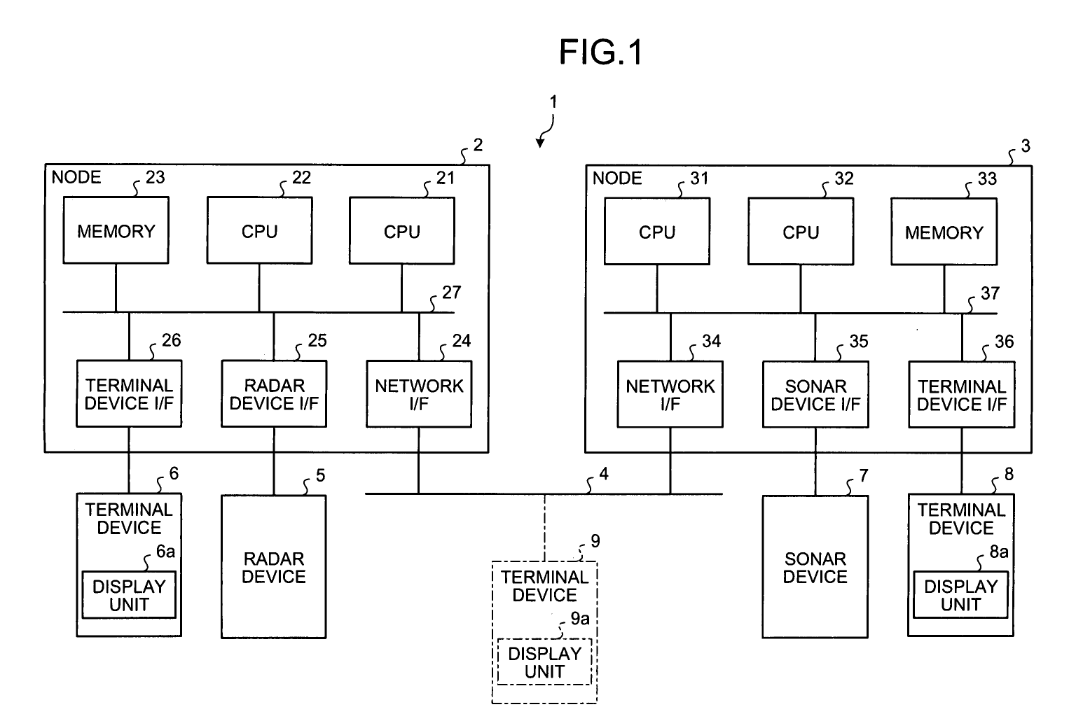

As illustrated in FIG. 1, a sensor information system 1 includes a plurality of nodes, for example, two nodes 2 and 3 that are connected to each other through a network 4. A radar device 5 and a terminal device 6 are connected to the node 2. The node 2 is a computer device that performs a predetermined signal processing and displays the signal processing result on a screen of a display unit 6a of the terminal device 6. As will be described later, the node 2 includes a signal processing application program (hereinafter, application program will also be simply referred to as “application”) that performs a predetermined signal processing on a signal of each of the radar device 5 and a sonar device 7, and an information displaying application program that displays the signal processing result on a signal of the radar device 5 on the display unit 6a.

The sonar device 7 and a terminal device 8 are connected to the node 3. The node 3 is a computer device that performs a predetermined signal processing and displays the signal processing result on a screen of a display unit 8a of the terminal device 8. As will be described later, the node 3 includes a signal processing application program that performs a predetermined signal processing on a signal of each of the sonar device 7 and the radar device 5, and an information displaying application program that displays the signal processing result on a signal of the sonar device 7 on the display unit 8a.

Also, as will be described later, a sensor signal of the radar device 5 is transmitted through the network 4 to the node 3, and a sensor signal of the sonar device 7 is transmitted through the network 4 to the node 2.

The node 2 displays radar information on the screen of the display unit 6a of the terminal device 6 to provide information related to a sensor signal of the radar device 5 to a user in a so-called real time manner. Likewise, the node 3 displays sonar information on the screen of the display unit 8a of the terminal device 8 to provide information related to a sensor signal of the sonar device 7 to a user in a real time manner.

Accordingly, in the embodiment, the information processing of sensor information from the two sensor devices, i.e., the radar device 5 and the sonar device 7, is performed in the two nodes 2 and 3, and the processing results, i.e., radar information and sonar information, are displayed respectively on the screens of the display units 6a and 8a of the terminal devices 6 and 8 in real time. For example, in the case of a ship, when an obstacle is sensed by the radar device 5, location information of the obstacle is displayed as sensor information on the screen in real time.

The node 2 includes two central processing units (CPUs) 21 and 22, a memory 23, a network interface (I/F) 24, a radar device interface (I/F) 25, and a terminal device interface (I/F) 26, which are connected to one another through a bus 27.

Likewise, the node 3 includes two central processing units (CPUs) 31 and 32, a memory 33, a network interface (I/F) 34, a sonar device interface (I/F) 35, and a terminal device interface (I/F) 36, which are connected to one another through a bus 37.

The buses 27 and 37 may be interconnections between or on the substrates of the nodes 2 and 3, respectively, or may be interconnections within chips of the nodes 2 and 3, respectively. The network I/Fs 24 and 34 are interfaces for connecting the nodes 2 and 3 to the network 4, respectively. The terminal device I/Fs 26 and 36 are interfaces for connecting the nodes 2 and 3 to the terminal devices 6 and 8, respectively. The node 2 and the radar device 5 are connected through the radar device I/F 25, and the node 3 and the sonar device 7 are connected through the sonar device I/F 35.

The network 4 may be a real-time network or a non-real-time network such as Ethernet (registered trademark).

Although FIG. 1 illustrates that the radar device 5 and the sonar device 7 are connected to the nodes 2 and 3 through the interfaces, respectively, the radar device 5 and the sonar device 7 may have network interfaces so that they can be connected directly to the network 4. In this case, the signals from the radar device 5 and the sonar device 7 are transmitted through the network 4 to the nodes 2 and 3, respectively.

Although it has been described that the terminal devices 6 and 8 are connected respectively to the nodes 2 and 3, a separate terminal device 9 connected to the network 4 may further be provided instead of or in addition to the terminal devices 6 and 8, as illustrated by a dotted and dashed line in FIG. 1. If the terminal device 9 is provided instead of the terminal devices 6 and 8, radar information and sonar information may be displayed on a display unit 9a of the terminal device 9. If the terminal device 9 is provided in addition to the terminal devices 6 and 8, radar information and sonar information may be displayed only on the display unit 9a of the terminal device 9 or also on the display unit 9a of the terminal device 9.

Although not illustrated in FIG. 1, the sensor information system 1 may include one or more terminal devices that include a display unit, a keyboard and the like and are connected to one of the nodes 2 and 3.

2. Software Configuration of System

The nodes 2 and 3 are not only application executing devices for processing a radar signal and a sonar signal and displaying radar information or sonar information, but also resource management apparatuses for managing resources such as a CPU time. That is, the nodes 2 and 3 perform not only a sensor information processing operation for processing a radar signal and a sonar signal and displaying the processing result as radar information or sonar information on the display units 6a and 8a of the terminal devices 6 and 8 in real time, but also a resource managing operation for processing the real-time sensor information. Thus, the nodes 2 and 3 are resource management apparatuses, each of which is a computer device that is implemented mainly by a software program that is operated to execute an application program on each node.

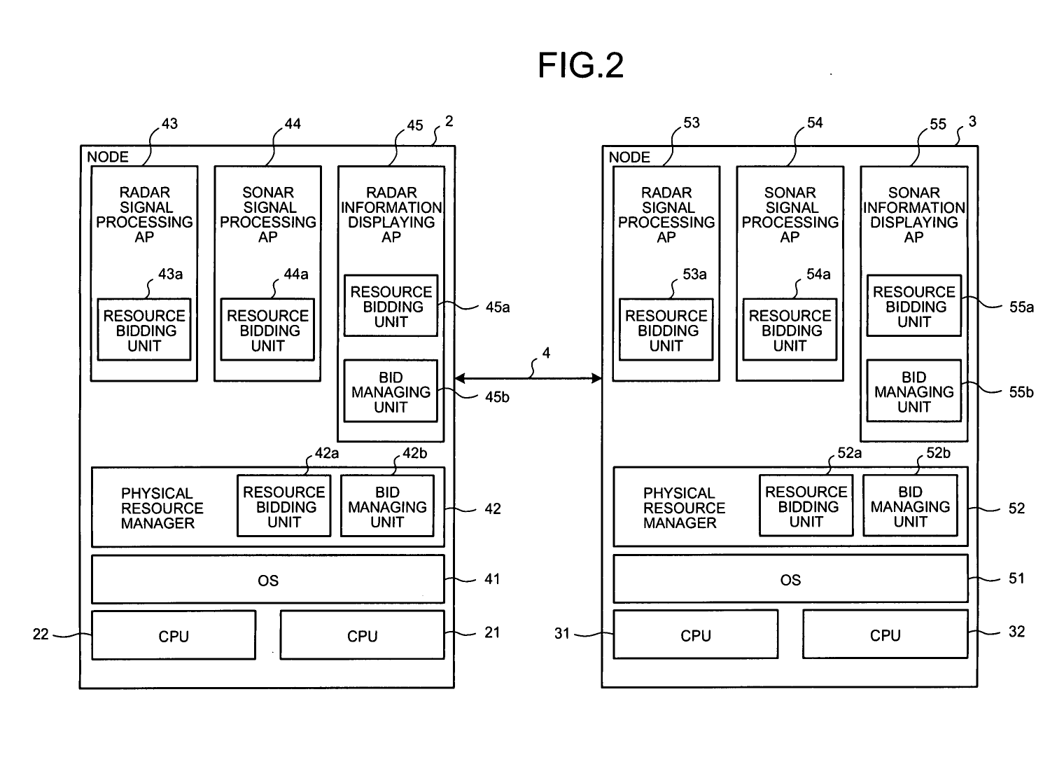

As illustrated in FIG. 2, in the node 2, one operating system (OS) 41 operates on two CPUs 21 and 22 that are hardware. The OS 41 is a multiprocessor-compatible OS, such as Windows (registered trademark) and LINUX (registered trademark). A physical resource manager 42 is installed on the OS 41 to manage a CPU time as a resource.

Three application programs, which are a radar signal processing application (AP) 43 as a radar signal processing unit, a sonar signal processing AP 44 as a sonar signal processing unit, and a radar information displaying AP 45 as a radar information displaying unit, operate on the OS 41 through the physical resource manager 42.

Likewise, in the node 3, one OS 51 operates on two CPUs 31 and 32 that are hardware. The OS 51 is also a multiprocessor-compatible OS. A physical resource manager 52 is installed on the OS 51 to manage a CPU time as a resource.

Three application programs, which are a radar signal processing AP 53, a sonar signal processing AP 54, and a sonar information displaying AP 55 operate on the OS 51 through the physical resource manager 52.

In executing each application program, the physical resource managers 42 and 52 each performs a predetermined processing operation for a bid from each application to manage a CPU time in order to execute each application for a CPU time bidden successfully by the application, as will be described later.

The software and hardware of each node that operate as the resource management apparatus is managed by one OS 41 or 51. In the embodiment, each node includes two CPUs. Even when each node includes a plurality of CPUs, one multiprocessor-compatible OS operates to manage the whole resources of each node. Physical resources are managed by the physical resource managers 42 and 52 that are implemented as middleware operating on each OS. Alternatively, the physical resource managers 42 and 52 may be implemented as a function in the OS.

The resource management apparatus includes a plurality of resource bidding units and a plurality of bid managing units. Specifically, in the node 2, the physical resource manager 42 includes a resource bidding unit 42a and a bid managing unit 42b.

The radar signal processing AP 43 includes a resource bidding unit 43a. The sonar signal processing AP 44 includes a resource bidding unit 44a. The radar information displaying AP 45 includes a resource bidding unit 45a and a bid managing unit 45b. Likewise, in the node 3, the physical resource manager 52 includes a resource bidding unit 52a and a bid managing unit 52b. The radar signal processing AP 53 includes a resource bidding unit 53a.

The sonar signal processing AP 54 includes a resource bidding unit 54a. The sonar information displaying AP 55 includes a resource bidding unit 55a and a bid managing unit 55b. The resource bidding units 42a, 43a, 52a, 53a, etc., are installed in respective processing units that are resource supplying/consuming modules (herein, the physical resource managers 42 and 52, the radar signal processing AP 43, the sonar signal processing AP 44, etc.).

Alternatively, a resource bidding unit may be installed only in some of the applications. For example, a resource bidding unit may not be provided in an application consuming little resource in order to skip the participation in a bidding process, while a resource bidding unit may be provided only in an application consuming much resource. In this case, the resource, which is to be consumed by the application not participating in a bidding process, need to be allocated separately and fixedly with some margin.

One bid managing unit or a plurality of bid managing units may be installed in each node. The bid managing unit may be implemented as independent middleware or a function in the OS, or may be implemented in any processing unit. The operation or communication in a bidding process is often simplified by implementing the bid managing unit in a supplier when one supplier and a plurality of consumers are provided and by implementing the bid managing unit in a consumer when one consumer and a plurality of suppliers are provided. In the embodiment, because the physical resource managers 42 and 52 (i.e., suppliers) merely supply a CPU usage rate to a plurality of applications (i.e., consumers), the bid managing units 42b and 52b are installed respectively in the physical resource managers 42 and 52. Also, because the sensor information displaying AP (i.e., a consumer) merely receives a CPU usage rate and sensor information from a plurality of applications (i.e., suppliers and producers), the bid managing units 45b and 55b are installed in the sensor information displaying AP. In the node 2, the bid managing unit 42b is installed in the physical resource manager 42, and the bid managing unit 45b is installed in the radar information displaying AP 45.

3. Supply and Consumption of Resource

3.1 Resource

The resources will be described next. The embodiment is an example based on a supply chain model in which not only a CPU usage rate, which is a physical resource, but also data, which is generated by an application program, is handled as a resource.

The reason why data is also handled as a resource is as follows. The signal processing unit for the sensor signals is separated from the information displaying unit that displays sensor information. If the sensor information is not treated as a resource and only the CPU usage rate is handled as the resource, there is a possibility that the resource allocation is performed regardless of the relationship between the supply and the consumption of the sensor information. For example, there can be a situation that the sonar signal processing APs 44 and 54 are allocated a CPU usage rate for execution, but the sonar information displaying AP 55 is not allocated a CPU usage rate and the application cannot be executed. In this case, a state in which the CPU is wasted to generate unused sensor information occurs. In order to avoid such a state while separating each signal processing unit and each information displaying unit, not only the CPU usage rate but also data is handled as the resource.

The CPU usage rate is the use percentage (%) of the CPU by each application per process unit time that will be described later. For example, if the process unit time is 1 second and the CPU usage rate is 30%, it means that the application can use the CPU for 300 ms. Although the CPU usage rate (%) is used in the embodiment, the CPU use time (ms, for example) may also be used. Also, in the embodiment, the data may be radar information and sonar information.

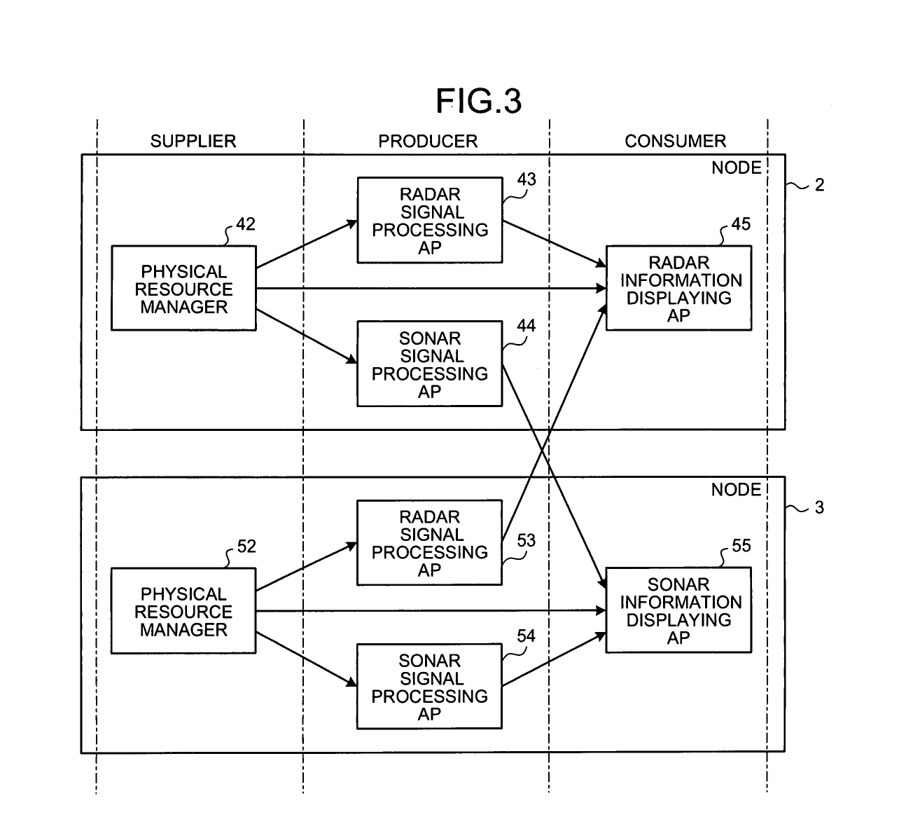

As illustrated in FIG. 3, in the supply chain model according to the embodiment, the physical resource managers 42 and 52 correspond to suppliers, the radar signal processing APs 43 and 53 and the sonar signal processing APs 44 and 54 correspond to producers, and the radar information displaying AP 45 and the sonar information displaying AP 55 correspond to consumers.

The physical resource managers 42 and 52, which are the suppliers that merely execute the supply of the resource, are middleware that execute the management of the CPU usage rate that is a physical resource. The physical resource managers 42 and 52 may be installed in the OS as a part of the OS.

The CPU usage rate is supplied from the physical resource managers 42 and 52, which are the suppliers, to the corresponding applications. In the case of FIG. 3, the CPU usage rate is supplied from the physical resource manager 42 to the radar signal processing AP 43, the sonar signal processing AP 44, and the radar information displaying AP 45. Similarly, the CPU usage rate is supplied from the physical resource manager 52 to the radar signal processing AP 53, the sonar signal processing AP 54, and the sonar information displaying AP 55.

Each of the radar signal processing APs 43 and 53 and the sonar signal processing APs 44 and 54, which are the producers, use the CPU in accordance with CPU usage rates to generate sensor information, and supplies the generated sensor information to the radar information displaying AP 45 or the sonar information displaying AP 55. That is, each sensor signal processing AP is the producer that supplies sensor information.

The radar information displaying AP 45 and the sonar information displaying AP 55, which are the consumers, use the CPU in accordance with CPU usage rates and use the sensor information but do not supply a resource to other applications. That is, each information displaying AP is the consumer that merely uses the CPU in accordance with the CPU usage rate and the sensor information but does not supply a resource to other applications.

Each processing unit, which is an application, operates only when all the resources to be consumed by the processing unit itself are successfully bidden. Each signal processing unit is provided in both of the nodes 2 and 3 in order to distribute loads between the nodes 2 and 3, but sensor information is generated if either one of them is executed. For example, the radar information displaying AP 45 is executed when it is allocated a CPU usage rate and it receives radar information supplied from either one of the radar signal processing APs 43 and 53.

3.2 Method for Supplying Resource

A method for supplying resources will be described next. The supply of sensor information, which is data, is performed by actually supplying sensor information from the signal processing AP to the sensor information displaying AP. For example, the radar signal processing AP 43 supplies radar information, which is obtained as a result of the signal processing operation, to the radar information displaying AP 45.

The supply of a CPU usage rate is conceptual and the CPU usage rate is not explicitly transferred. An application program is created so as to be executed using the CPU only when the CPU usage rate is successfully bidden. If the actual behavior of an application is unreliable because the application is created by a third party or for any other reason, whether the actual CPU usage rate by the application corresponds to the successfully-bidden CPU usage rate may be checked by monitoring the state of the OS with the physical resource managers 42 and 52. In this case, if the application uses the CPU at a rate higher than the successfully-bidden CPU usage rate, the application can be forcibly terminated by an interrupt processing. Thus, the allocation of the CPU usage rate is forcibly maintained. The above-described resource allocation is performed through a bidding operation of the resource management apparatus.

3.3 Method for Determining Resource Allocation

(a) CPU Usage Rate

First, a method for determining the CPU usage rate, i.e., the consumption amount and the supply amount of a CPU, which is a physical resource, will be described. Each application calculates the CPU usage rate (consumption amount), at which the application uses the CPU per process unit time, and then the application specifies or determines the CPU usage rate. The determination may be implemented by explicitly describing a numerical value or a calculation expression in a source code of the application by an application creator. Alternatively, the determination may be made in a compiling operation by a compiler. Further alternatively, each application may monitor the state of the physical resource managers 42 and 52 or the OS to measure the CPU usage rate when the application is executed so as to estimate the future physical resource use amount from the measurement history.

The physical resource managers 42 and 52 calculate the supply amount of the resource that can be supplied to the application. In the embodiment, the supply amount to the application is a value resulting from subtracting a margin for the operation of the OS and middleware and for the security from the percentage indicative of the total use time corresponding to the number of CPUs. In the embodiment, each node sets the supply amount to 180%, which is resulted from subtracting a margin of 20% from 200% corresponding to two CPUs.

(b) Sensor Information

Next, a method for determining the consumption amount and the supply amount of sensor information will be described. The consumption amount and the supply amount of sensor information, which is a resource other than physical resources, are specified by explicitly describing a numeric value or a calculation expression in a source code of the application as a part of the logic of the application by an application creator.

The sonar signal processing AP 44 receives a sensor signal from the sonar device 7, which is the sensor device, at predetermined sampling periods. The amount of the sensor signal (e.g., the bit rate) is the consumption amount. Also, the sonar signal processing AP 44 performs a predetermined signal processing operation to supply sensor information to the sonar information displaying AP 55. The amount of the sensor information (e.g., the bit rate) is the supply amount.

As will be described later, the consumption amount and the supply amount vary depending on a bidding operation. The CPU usage rate of each node also varies depending on the sensor signal amount supplied to the node. The CPU usage rate of the node 2 varies depending on the sensor signal amount supplied to the node 2. Likewise, the CPU usage rate of the node 3 varies depending on the sensor signal amount supplied to the node 3. Therefore, the total amount of sensor signals output from a device, such as the radar device 5, is distributed to the node 2 and the node 3, and each node needs a CPU usage rate corresponding to the distributed amount.

(c) Notification of Resource Allocation

In each processing unit, the consumption amount or the supply amount, which is determined or specified in the above-described procedure, is notified to the resource bidding unit implemented in the processing unit. The resource bidding unit performs a bidding operation corresponding to the consumption amount or the supply amount for the bid managing unit.

4. Configuration of Resource Management Apparatus

4.1 Resource Management Apparatus

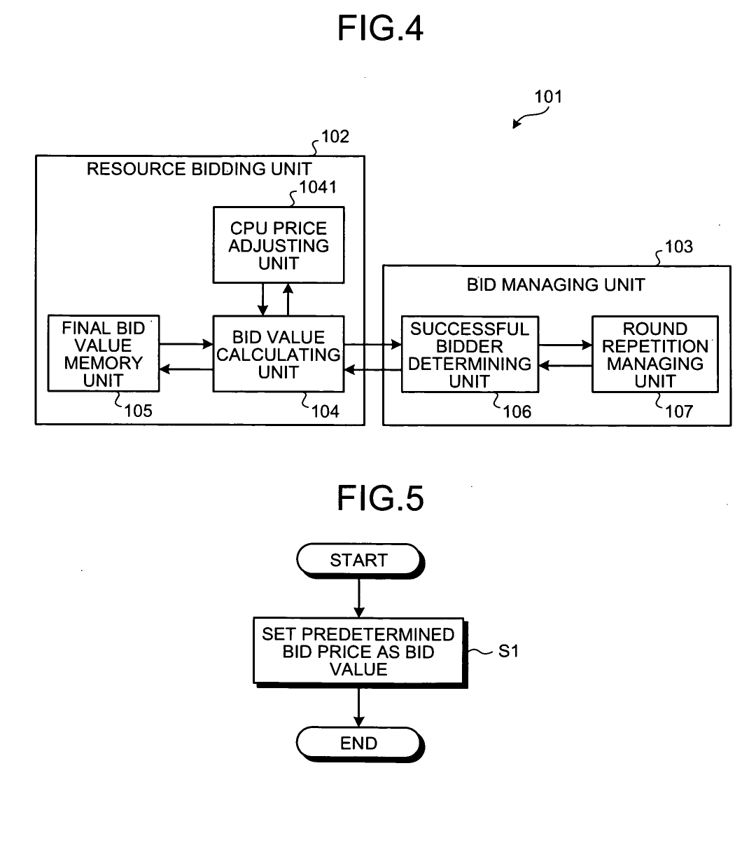

In the embodiment, a resource management apparatus 101 includes a plurality of resource bidding units 102 and a plurality of bid managing units 103. FIG. 4 illustrates the data flow between one resource bidding unit 102 and one bid managing unit 103 in order to show the relationship between the resource bidding unit 102 and the corresponding bid managing unit 103 in each application.

In the case of the node 2, concerning the CPU usage rate, each of the resource bidding units 42a, 43a, 44a and 45a corresponds to the resource bidding unit 102, and the bid managing unit 42b corresponds to the bid managing unit 103. Concerning the radar information, each of the resource bidding unit 43a (and 53a) and 45a corresponds to the resource bidding unit 102, and the bid managing unit 45b corresponds to the bid managing unit 103.

The resource bidding unit 102 includes a bid value calculating unit 104, a CPU price adjusting unit 1041, and a final bid value memory unit 105. The bid managing unit 103 includes a successful bidder determining unit 106 and a round repetition managing unit 107.

An operation of each component of the resource management apparatus 101 will be described below in detail.

4.2 Resource Bidding Unit

First, a processing operation of the resource bidding unit 102 will be described. The resource bidding unit 102 submits a bid for the resource of the consumption amount or the supply amount obtained by the above-described determination to the bid managing unit 103, namely, provides the self-resource information. The resource bidding unit 102 performs the bidding operation for the bid managing unit 103 over a plurality of times, that is, a plurality of rounds.

In each round, the bid value calculating unit 104 calculates a bid value as a bid price. The price has to be set so as to maximize the profit of the processing unit by buying or selling the resource at the price.

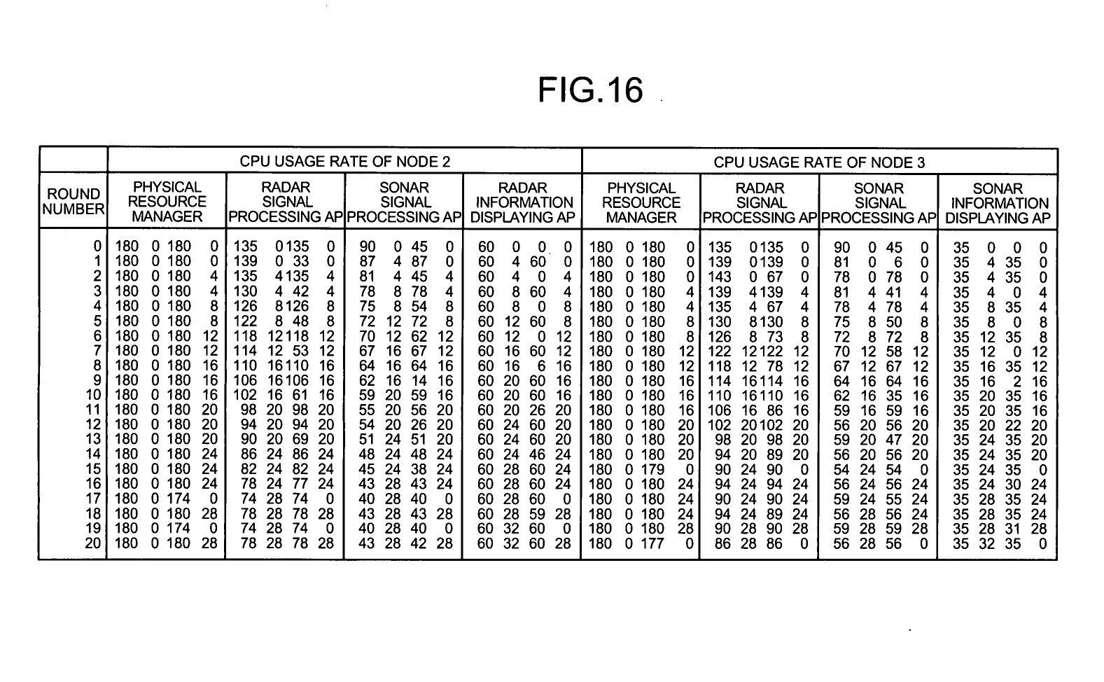

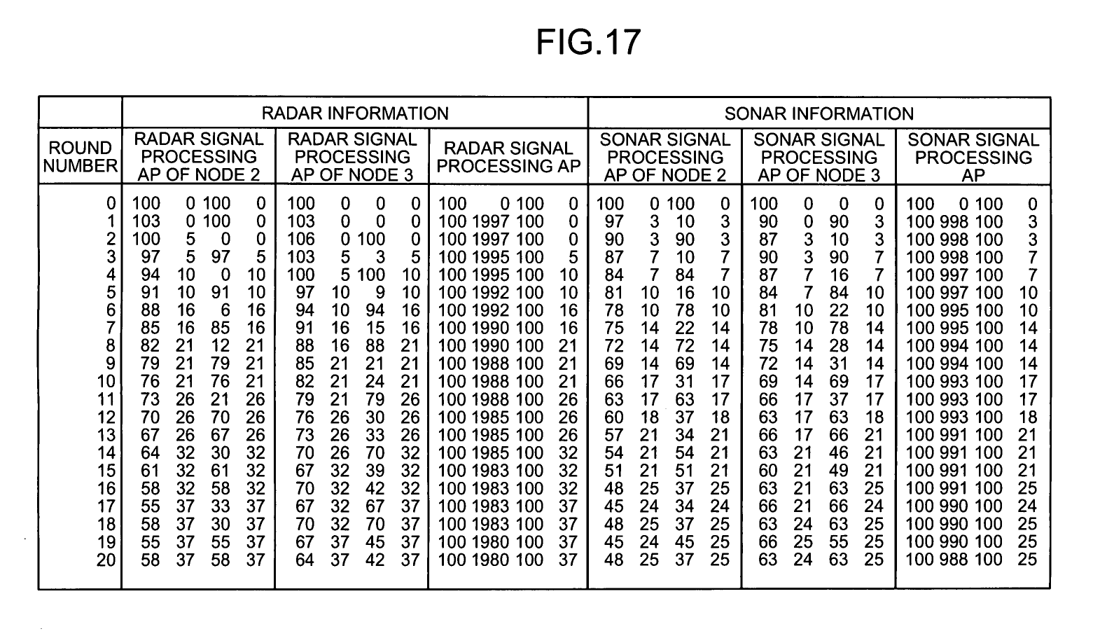

The specific operation of the bid value calculating unit 104 varies depending on whether the processing unit is the supplier, the producer or the consumer. Each case will be described below. FIG. 16 shows the bid amount, the bid value, the successful bid amount, and the successful bid value in each processing unit of the nodes 2 and 3 concerning the CPU usage rate. FIG. 17 shows the bid amount, the bid value, the successful bid amount, and the successful bid value in each processing unit concerning data. In FIGS. 16 and 17, listed numerals in the sections represent the bid amount, the bid value, the successful bid amount, and the successful bid value, sequentially from the left. Hereinafter, a description will be given with reference to FIGS. 16 and 17.

(a) In the Case of Supplier

The supplier need not be reluctant to sell the resource that can be supplied by the supplier. Therefore, regardless of how low the price is, the supplier may perform a bidding process so as to sell the resource as much as possible. Thus, the bid value calculating unit 104 of the supplier may always provide a fixed bid value. In the embodiment, the physical resource managers 42 and 52, which are the suppliers, always bid for a CPU usage rate at a price ‘0’. Thus, the supplier may not be provided with the final bid value memory unit 105.

As illustrated in FIG. 5, the bid value calculating unit 104 always sets a predetermined bid price, for example, a fixed value of ‘0’ as a bid value (step S1).

(b) In the Case of Producer

If a resource can be sold at a high price, the producer may purchase a resource at a high price to generate the resource. If the sale price is lower than the purchase price, the producer needs to stop the purchase and sale. Thus, the bid value calculating unit 104 of the producer performs the following process.

In the first round, the bid value calculating unit 104 adopts a value recorded in the final bid value memory unit 105 as a bid value. An initial value of ‘0’ is recorded in the final bid value memory unit 105. In the second and subsequent rounds, the bid value calculating unit 104 adjusts the bid value depending on whether the bid was successful in the previous round.

Concerning a resource to be supplied (e.g., data of radar information in the radar signal processing AP 43), the bid value calculating unit 104 performs a bidding operation using an estimated value as a bid value (sale price). The estimated value is the sum of bid values (purchase prices) of resources to be consumed (e.g., CPU usage rates for the radar signal processing AP 43). For example, the estimated value is calculated by summing up the successful bid values of the resources to be consumed in the previous round. Successful bid values of other processing units may be used when the bid by the processing unit was not successful. Concerning the resource to be consumed, the bid value calculating unit 104 performs a calculation, in which the resource bid value is increased by a predetermined amount if the bid for the resource was not fully successful in the previous round.

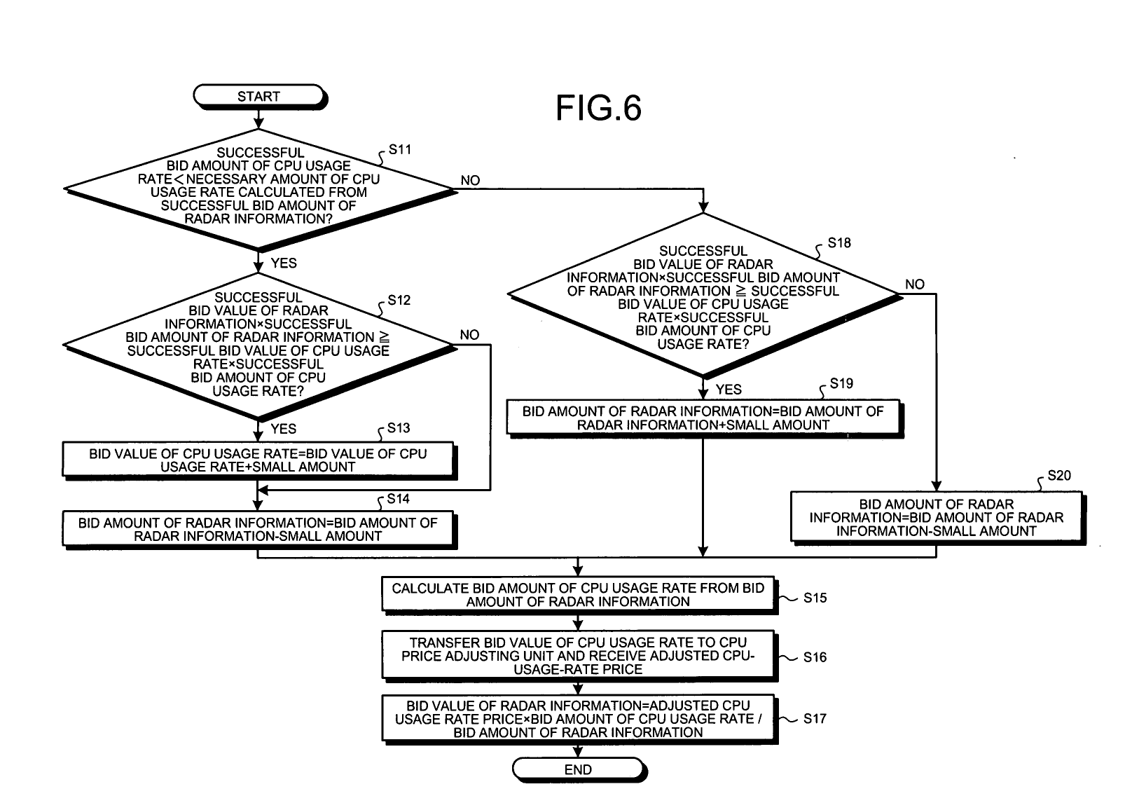

The process of FIG. 6 is executed by the radar signal processing AP 43 immediately before the start of each round in a bidding process to determine a bid value for each round. The determined bid value is provided to the bid managing unit 103.

First, the bid value calculating unit 104 determines whether the previous successful bid amount of the CPU usage rate is smaller than the necessary amount of the CPU usage rate calculated from the successful bid amount of radar information (step S11). If the previous successful bid amount of the CPU usage rate is smaller than the necessary amount of the CPU usage rate calculated from the successful bid amount of the radar information (step S11: YES), the bid value calculating unit 104 determines whether the product of the successful bid value of the radar information and the successful bid amount of the radar information is equal to or greater than the product of the successful bid value of the CPU usage rate and the successful bid amount of the CPU usage rate (step S12).

Incidentally, FIGS. 16 and 17 show an example of the case where the radar signal processing AP 43 requires a CPU usage rate of ‘135’ to generate radar information of ‘100’.

For example, it is determined YES at step S11 in the round 5 of the radar signal processing AP 43 of the node 2. The successful bid amount of the CPU usage rate in FIG. 16 is ‘48’ while the successful bid amount of the radar information in FIG. 17 is ‘91’. In this case, the CPU usage rate calculated from the successful bid amount ‘91’ of radar information is ‘123’ and the successful bid amount of the CPU usage rate becomes equal to or greater than ‘48’.

If the product of the successful bid value of the radar information and the successful bid amount of the radar information is equal to or greater than the product of the successful bid value of the CPU usage rate and the successful bid amount of the CPU usage rate (step S12: YES), the process proceeds to step S13. If it is determined YES at step S12, it means that the bid is profitable (i.e., the sale price exceeds the purchase price).

For example, in the round 19 of the radar signal processing AP 43 of the node 2, the product of the successful bid amount ‘74’ and the successful bid value ‘0’ for the CPU usage rate in FIG. 16 is ‘0’ while the product of the successful bid amount ‘55’ and the successful bid value ‘37’ for the radar information in FIG. 17 is ‘2035’.

If it is determined YES at step S12, the CPU usage rate of the radar signal processing AP 43 may be increased, and therefore the bid value calculating unit 104 adds a predetermined small amount (d1) to the bid value of the CPU usage rate (step S13). Herein, the added small amount is ‘4’. In FIG. 16, the bid value is increased from ‘74’ to ‘78’ from the round 19 to the round 20 of the radar signal processing AP 43 of the node 2.

If the product of the successful bid value of the radar information and the successful bid amount of the radar information is not equal to or greater than the product of the successful bid value of the CPU usage rate and the successful bid amount of the CPU usage rate (step S12: NO), the bid value calculating unit 104 subtracts a predetermined small amount (d2) from the bid amount of the radar information in order to decrease the bid amount of the radar information of the radar signal processing AP 43 (step S14). If it is determined NO at step S12, it means that the bid is not profitable.

For example, in the round 18 of the radar signal processing AP 43 of the node 2, the product of the successful bid amount ‘78’ and the successful bid value ‘28’ for the CPU usage rate in FIG. 16 is ‘2184’ while the product of the successful bid amount ‘30’ and the successful bid value ‘37’ for the radar information in FIG. 17 is ‘1110’. In this case, the radar signal processing AP 43 decreases the bid amount of the radar information from ‘58’ to ‘55’ from the round 18 to the round 19.

Thereafter, the bid value calculating unit 104 calculates the bid amount of a changed CPU usage rate from the bid amount of the radar information (step S15). The bid value calculating unit 104 transfers the bid value of the CPU usage rate to the CPU price adjusting unit 1041, and the CPU price adjusting unit 1041 calculates an adjusted CPU-usage-rate price (step S16). A method for calculating the adjusted CPU-usage-rate price by the CPU price adjusting unit 1041 will be described later in detail.

Thereafter, the bid value calculating unit 104 calculates the bid value of the radar information by dividing the product of the adjusted CPU-usage-rate price and the bid amount by the bid amount of the radar information (step S17).

If the previous successful bid amount of the CPU usage rate is not smaller than the necessary amount of the CPU usage rate calculated from the successful bid amount of the radar information (step S11: NO), that is, if the CPU usage rate necessary to process the radar information is ensured, the bid value calculating unit 104 determines whether the product of the successful bid value of the radar information and the successful bid amount of the radar information is equal to or greater than the product of the successful bid value of the CPU usage rate and the successful bid amount of the CPU usage rate (step S18).

For example, it is determined NO at step S11 in the round 18 of the radar signal processing AP 43 of the node 2. The successful bid amount of the CPU usage rate is ‘78’ as shown in FIG. 16 while the successful bid amount of the radar information is ‘30’ as shown in FIG. 17. In this case, the necessary CPU usage rate corresponding to the successful bid amount ‘30’ of the radar information is ‘41’ and thus the successful bid amount of the CPU usage rate is smaller than ‘78’.

If the product of the successful bid value of the radar information and the successful bid amount of the radar information is equal to or greater than the product of the successful bid value of the CPU usage rate and the successful bid amount of the CPU usage rate (step S18: YES), that is, if the bid is profitable, the bid value calculating unit 104 adds a predetermined small amount (d3) to the bid amount of the radar information in order to increase the bid amount of the radar information of the radar signal processing AP 43 (step S19).

If the product of the successful bid value of the radar information and the successful bid amount of the radar information is not equal to or greater than the product of the successful bid value of the CPU usage rate and the successful bid amount of the CPU usage rate (step S18: NO), that is, if the bid is not profitable, the bid value calculating unit 104 subtracts a predetermined small amount (d4) from the bid amount of the radar information in order to decrease the bid amount of the radar information of the radar signal processing AP 43 (step S20).

Thereafter, the bid value calculating unit 104 performs the operation of step S15, and after the CPU price adjusting unit 1041 performs the operation of step S16, the bid value calculating unit 104 performs the operation of step S17.

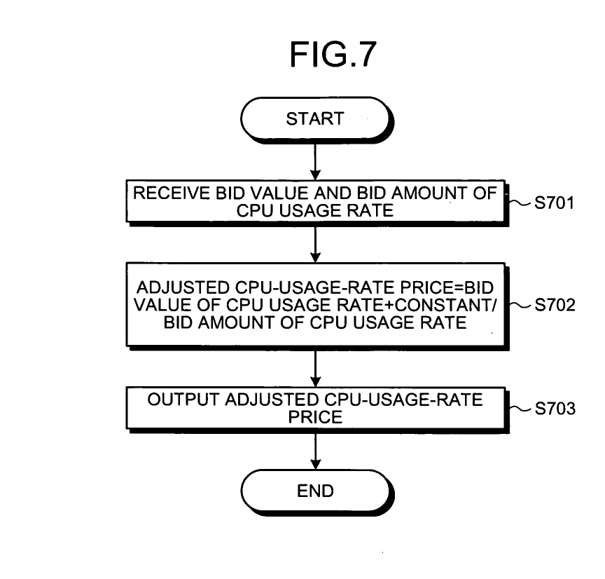

Next, a method for calculating the adjusted CPU-usage-rate price by the CPU price adjusting unit 1041 at step S16 will be described in detail with reference to FIG. 7.

First, the bid value calculating unit 104 inputs the bid amount and the bid value of the CPU usage rate to the CPU price adjusting unit 1041 (step S701). Then, the CPU price adjusting unit 1041 calculates an adjusted CPU-usage-rate price by adding a constant divided by the bid amount of the CPU usage rate to the bid value of the CPU usage rate (step S702). Finally, the CPU price adjusting unit 1041 outputs the calculated adjusted CPU-usage-rate price to the bid value calculating unit 104 (step S703) and ends the process.

(c) In the Case of Consumer

The consumer purchases the resource, which is consumed by the consumer itself, within the range to the upper limit of the purchase price depending on the importance of the application in the aspect, namely, the situation, and performs processing operation. The importance of each application may be changed depending on the situation. The upper limit of the purchase price may be described in the source code of the application by the application creator. Alternatively, the application may calculate the upper limit by recognizing the aspect. Further alternatively, a user may specify the upper limit directly or indirectly through the terminal.

In the embodiment, on the assumption that the radar information is more important than the sonar information, the upper limit of the sum of the purchase prices of the resources of the radar information displaying AP 45 is set to ‘200000’ and the upper limit of the sum of the purchase prices of the resources of the sonar information displaying AP 55 is set to ‘100000’. If the resource cannot be bought within the ranges, the purchase of the resource in unit time is abandoned. Thus, a bid in which the importance of a sensor signal is reflected is performed.

The bid value calculating unit 104 adopts the value recorded in the final bid value memory unit 105 as the bid value in the first round. An initial value ‘0’ is recorded in the final bid value memory unit 105. In the second and subsequent rounds, the bid value calculating unit 104 adjusts the bid value depending on whether the bid was successful in the previous round.

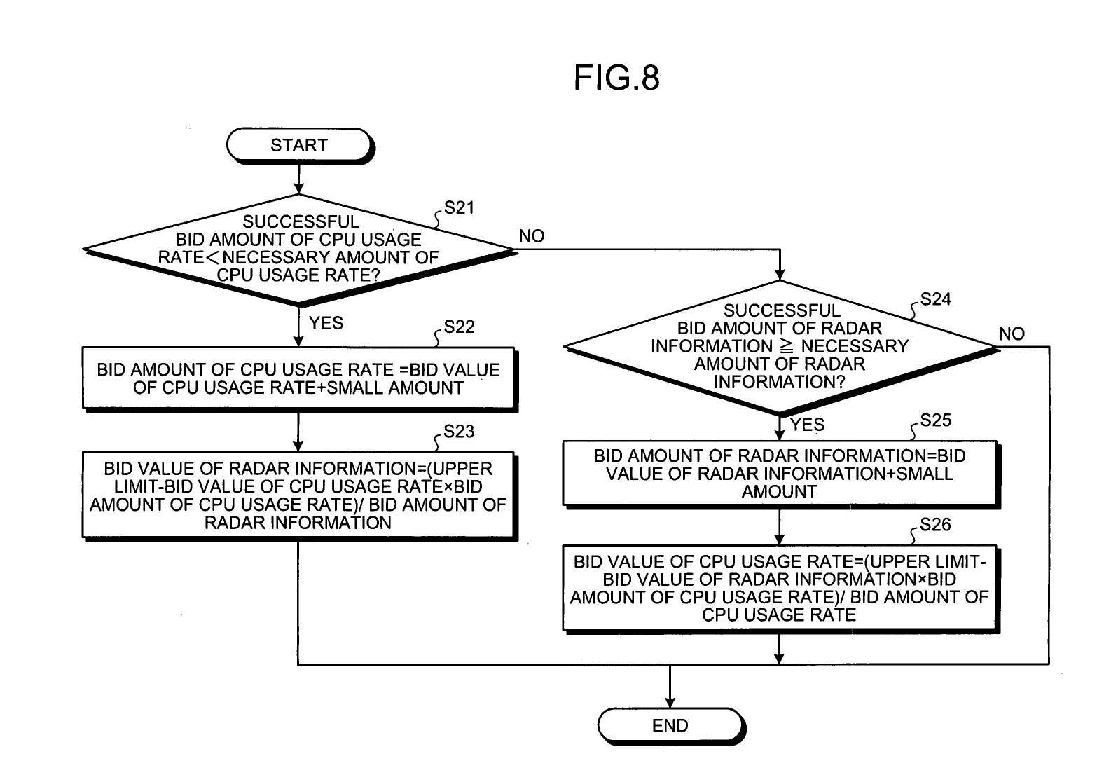

First, as illustrated in FIG. 8, the bid value calculating unit 104 determines whether the successful bid amount of the CPU usage rate is smaller than the necessary amount of the CPU usage rate (step S21).

Herein, the necessary amount is a fixed value. For example, as illustrated in FIG. 16, the necessary amount of the CPU usage rate of the radar information displaying AP 45 of the node 2 is ‘60’ and therefore the successful bid amount is ‘60’.

If the successful bid amount of the CPU usage rate is smaller than the necessary amount of the CPU usage rate (step S21: YES), the bid value calculating unit 104 increases the bid value of the CPU usage rate by a predetermined small amount (d5) (step S22).

Thereafter, the bid value calculating unit 104 calculates the bid value of the radar information by subtracting the product of the bid value of the CPU usage rate and the bid amount of the CPU usage rate from the upper limit and dividing the subtraction result value by the bid amount of the radar information (step S23). That is, the bid value of the radar information is determined within the range that the sum of the product of the bid value of the CPU usage rate and the bid amount of the CPU usage rate and the product of the bid value of the radar information and the bid amount of the radar information does not exceed the upper limit.

If the successful bid amount of the CPU usage rate is equal to or greater than the necessary amount of the CPU usage rate (step S21: NO), the bid value calculating unit 104 determines whether the successful bid amount of the radar information is equal to or greater than the necessary amount of the radar information (step S24).

Herein, the necessary amount of the radar information is a fixed value. For example, the necessary amount of the radar information of the radar information displaying AP 45 of the node 2 is ‘100’ and therefore the successful bid amount is ‘100’ as illustrated in FIG. 17.

If the successful bid amount of the radar information is equal to or greater than the necessary amount of the radar information (step S24: YES), the bid value calculating unit 104 increases the bid value of the radar information by adding a predetermined small amount (d6) (step S25). This is to set the CPU usage rate to a lower bid value as a result of setting the radar information to a higher bid value.

In other words, the bid value calculating unit 104 calculates the bid value of the CPU usage rate by subtracting the product of the bid value of the radar information and the bid amount of the radar information from the upper limit and dividing the subtraction result value by the bid amount of the CPU usage rate (step S26). That is, the bid value of the CPU usage rate is determined within the range that the sum of the product of the bid value of the CPU usage rate and the bid amount of the CPU usage rate and the product of the bid value of the radar information and the bid amount of the radar information does not exceed the upper limit.

If the successful bid amount of the radar information is not equal to or greater than the necessary amount of the radar information at step S24 (step S24: NO), the bid value calculating unit 104 ends the process.

4.3 Bid Managing Unit

The process of the bid managing unit 103 will be described next. The bid managing unit 103 determines which processing unit wins the bid for the resource based on the bid of each resource bidding unit 102, namely, the bidding information, and notifies the successful bid result to the resource bidding unit 102 of each processing unit. The successful bid result information includes information on whether the processing unit won the bid, and information on the successful bid value (which is not necessarily the successful bid value of the processing unit but may be the successful bid value of other processing units when the bid by the processing unit was not successful).

When receiving the successful bid result information, the resource bidding unit 102 of each processing unit performs an operation for a process unit time based on the successful bid result information. When finally winning the resource to be consumed, the processing unit performs a resource consuming operation. The processing unit, which failed in all the resources to be consumed in a process unit time, usually enters a so-called sleep state without performing any process within the process unit time. If some operation is possible even when a bid for a portion of the resource to be consumed is unsuccessful, the processing unit performs a processing operation on the possible portion. In contrast, the processing unit failing to win a bid for the resource to be supplied does not supply the resource in the next process unit time.

When winning a bid for the CPU usage rate, which is the physical resource, each application performs predetermined processing using the CPU in the next process unit time for a time obtained as a result of the successful bid. When winning a bid for the data, which is the non-physical resource, each application receives the data corresponding to the successful bid amount.

For example, the radar signal processing AP 43 is executed for the CPU time obtained as a result of the successful bid. As described above, the radar information displaying AP 45 is executed for the CPU time obtained as a result of the successful bid using the data obtained as a result of the successful bid, when both a bid for the CPU usage rate and a bid for the data (i.e., a successful bid of any one of the radar signal processing APs 43 and 53) are successful.

(a) Round Management

The round will be explained next. In the embodiment, the number of rounds, i.e., the number of repetitions is the condition for discontinuing a bid. That is, it is managed so that the bid process is not performed exceeding the predetermined number of rounds. The round repetition managing unit 107 of the bid managing unit 103 counts the number of rounds for each process unit time, and performs a monitoring/managing operation so that the determination of a successful bidder is performed only a predetermined number of times.

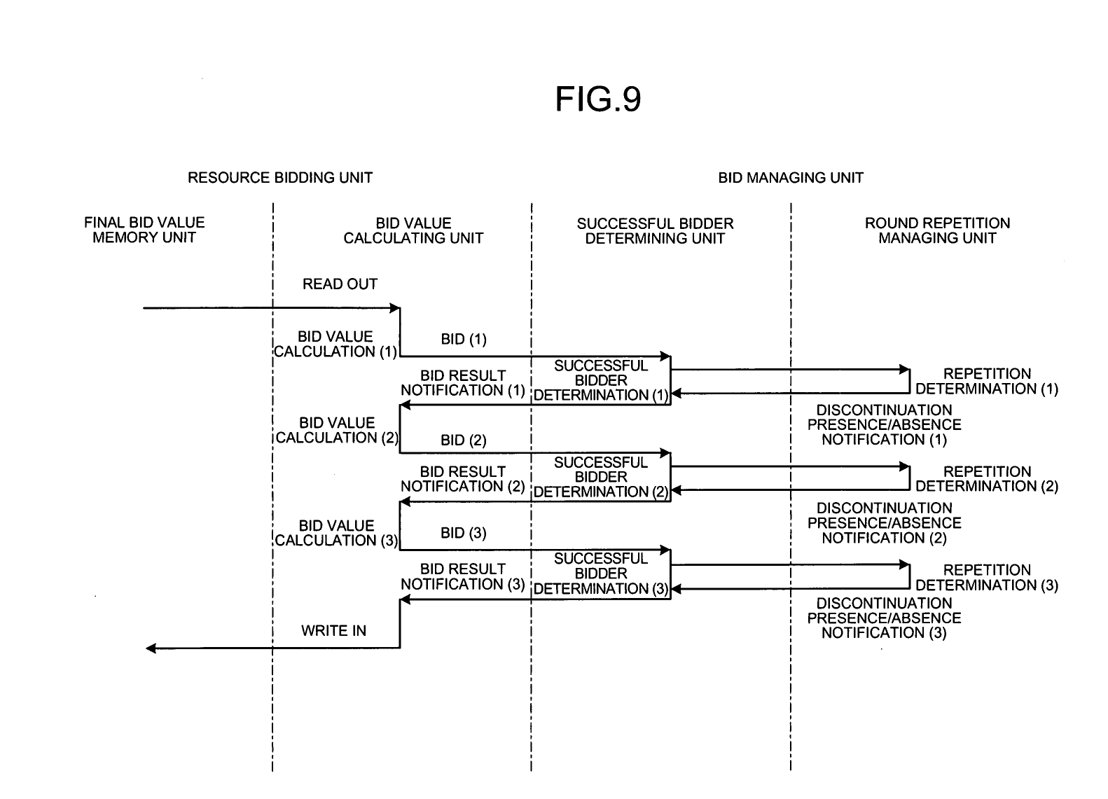

Referring to FIG. 9, the resource bidding unit 102 initially reads the final bid value of the previous round from the final bid value memory unit 105, calculates the bid value by means of the final bid value, and performs a bid (Bid (1)). With regard to the bid (1), the bid managing unit 103 performs a successful bid process and determines a successful bidder (Successful Bid (1)). In response to the successful bid (1), the bid value of the next (i.e., second) round is calculated to perform a bid again (Bid (2)). With regard to the bid (2), the bid managing unit 103 performs a successful bid process and determines a successful bidder (Successful Bid (2)). Further, in response to the successful bid (2), a bid is performed again (Bid (3)) and a successful bid process is performed. In the first round and the second round, the round repetition managing unit 107 does not output a discontinuation notification, which will be described later, to the successful bidder determining unit 106.

In this way, the round repetition managing unit 107 counts the successful bid process for one bid as one round, and when a bid is input or a successful bid result is output, the round repetition managing unit increments the number of rounds to count the number of rounds.

If the number of rounds reaches a predetermined number, the round repetition managing unit 107 detects that the number of rounds has reached the predetermined number. The detection result is notified as a discontinuation notification to the successful bidder determining unit 106. The successful bidder determining unit 106 notifies the resource bidding unit 102 of the discontinuation notification information. When receiving the discontinuation notification, the bid value calculating unit 104 writes the final bid value of the successful bid information in the final bid value memory unit 105 without calculating the bid value again.

In the above manner, the bid process is prevented from being performed exceeding the predetermined number of rounds as the discontinuation condition of the bidding process. Thus, the resource management apparatus according to the embodiment is configured to ensure the bid process to be completed within a predetermined time.

(b) Process Unit Time

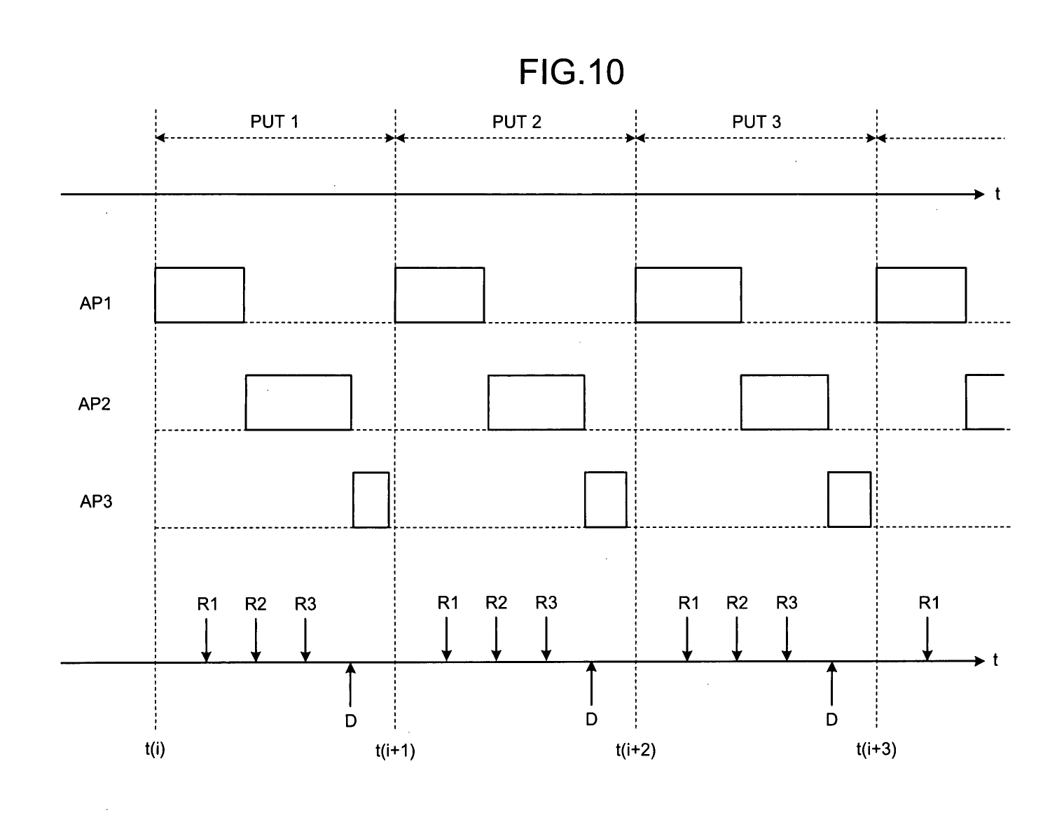

The process unit time will be described next. Herein, the process unit time is a execution time of each application. FIG. 10 shows the case where three applications of the node 2 (the radar signal processing AP 43, the sonar signal processing AP 44, and the radar information displaying AP 45) are executed. FIG. 10 shows that the three applications AP1, AP2 and AP3 are executed for a predetermined time corresponding to a CPU usage rate that is a resource allocated for each process unit time.

For each process unit time, the allocation of a resource for each application in the next process unit time is determined by the bid. In a process unit time PUT1 from a time t(i) to a time t(i+1), a predetermined number of bids are performed to finally determine a successful bidder, as described above. In the embodiment, the predetermined number is three. Each application is executed as much as the allocated CPU usage rate in response to the determined successful bid result. In FIG. 10, the CPU usage rate of each application in a process unit time PUT2 between a time t(i+1) to a time t(i+2) is determined through the bid process in the process unit time PUT1.

Referring to FIG. 10, after completion of the first bid R1, the second bid R2 is performed and then the third bid R3 is performed. After three bids are performed, the successful bid is finally determined at a timing D. In response to the successful bid result, each application is executed as much as the allocated CPU usage rate in the next process unit time.

Likewise, the CPU usage rate of each application in a process unit time PUTS is determined through the bid process in the process unit time PUT2. In this manner, the CPU usage rate of each application in the next process unit time is determined through the bid process in the previous process unit time.

(c) Successful Bidder Determining Unit

When receiving the bid information, the successful bidder determining unit 106 of the bid managing unit 103 determines which application is to succeed in a bid for the resource.

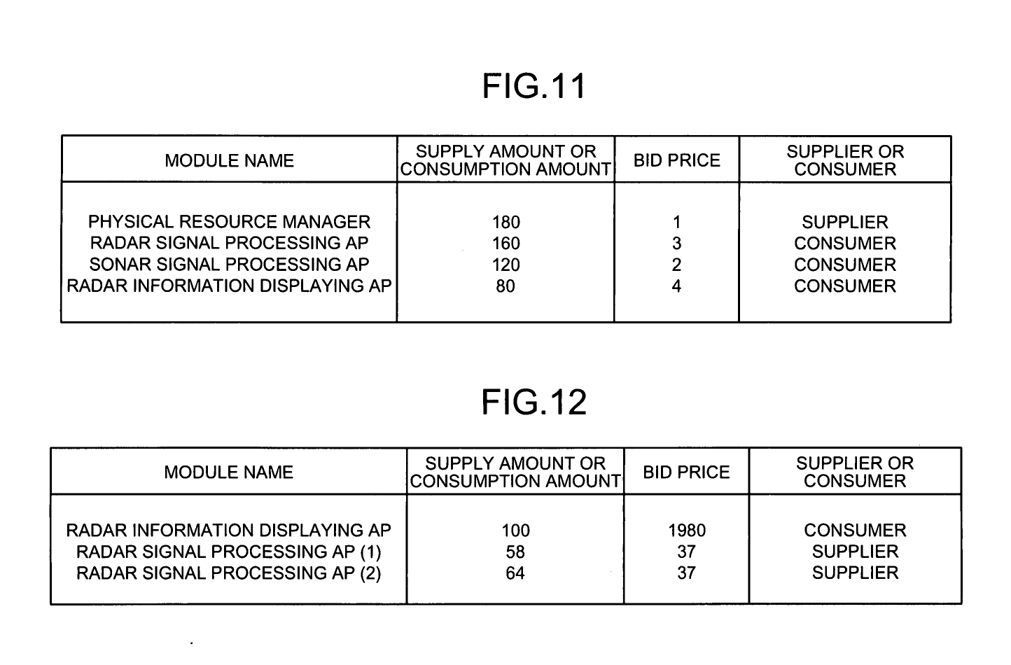

An operation of the successful bidder determining unit 106 will be described in the context of an exemplary case where the bid managing unit 42b of the physical resource manager 42 of the node 2 performs a bidding operation for bid information illustrated in FIG. 11.

As shown in FIG. 11, the bid information includes the module name, the supply amount or the consumption amount, the bid value, and the discrimination between the supplier and the consumer. The module name represents each processing unit, and it may be expressed by a numerical value such as a process number as well as a character string. The supply amount or the consumption amount specifies the supply or consumption amount of resources in the quantity in the unit defined for each resource. In FIG. 11, the CPU usage rate is specified in percentage. The bid value, which is the bid price, specifies the price of the resource to be consumed or supplied in virtual currency. The specification may be represented in the unit price for each unit of the resource, or may be represented in the total sum (i.e., the product of the unit price and the quantity). In FIG. 11, the unit price for each unit usage rate is represented.

An operation of the successful bidder determining unit 106 will be described next. First, a description will be given on an operation of the successful bidder determining unit 106 in the case of one supplier and a plurality of consumers present, such as the case of the CPU usage rate allocation. An operation of the bid managing unit 42b of the physical resource manager 42 will be described. In this case, the resource is allocated for the bids from the consumers in descending order of bid values until there is no supply amount left, or until the bid values of the bids from the consumers fall below the bid value of the bid from the supplier.

In this case, the successful bid value is the higher one of the maximum bid value from the consumers and the bid value of from the supplier. The maximum bid value from the consumers is the highest value in the bids from the consumers each failing to be allocated the resource reaching the bid amount.

For example, if a bid illustrated in FIG. 11 is performed, the supply amount of 180% from the physical resource manager 42 is allocated to each application depending on the consumption amount. In descending order of bid values, the usage rate of 80% is first allocated to the radar information displaying AP 45. Then, the remaining supply amount of 100% is allocated for the radar signal processing AP 43 representing 160%. Because the bid value ‘3’ of the radar signal processing AP 43 (to which the resource satisfying all of the bid amount of 160% is not allocated) is higher than the bid value ‘1’ of the physical resource manager 42, the successful bid value is ‘3’.

An operation of the successful bidder determining unit 106 will be described next in the context of an exemplary case where the bid managing unit 45b of the radar information displaying AP 45 of the node 2 performs a bidding operation for bid information illustrated in FIG. 12.

Referring to FIG. 12, the fact that the consumption amount of the radar information displaying AP 45 is ‘100’ means that the radar information displaying AP 45 cannot perform a display process unless it receives 100% of data. The fact that the supply amount of the radar signal processing AP 43 of the node 2 is ‘58’ means that the maximum of the percentage (%) of supplying and processing the radar information by the radar signal processing AP 43 is ‘58’. The maximum value ‘58’ is a value determined from the CPU usage rate used by the radar signal processing AP 43 in the node 2, which is set to allow 58% of the radar information 100% to be processed by the radar signal processing AP 43. Likewise, the fact that the supply amount of the radar signal processing AP 53 of the node 3 is ‘64’ means that the maximum of the percentage (%) of supplying and processing the radar information by the radar signal processing AP 53 is ‘64’. The maximum value ‘64’ is a value determined from the CPU usage rate used by the radar signal processing AP 53 in the node 3, which is set to allow 64% of the radar information 100% to be processed by the radar signal processing AP 53.

The fact that the bid value of the radar information displaying AP 45 is ‘1980’ means that the maximum of the bid price of the radar information displaying AP 45 is ‘1980’. The fact that the bid value of the radar signal processing AP 43 of the node 2 and the bid value of the radar signal processing AP 53 of the node 3 are both ‘37’ means that the minimum values of the bid prices are both ‘37’.

Herein, because the bid value is the unit price for each unit usage rate of the CPU usage rate, it is unnecessary to consider the CPU usage rate in comparing the sizes of the bid values. However, if the bid is to be performed using the total sum as the bid value, it is necessary for the successful bidder determining unit 106 to calculate the unit price by division of the bid value by the CPU usage rate and determine the successful bidder by comparison of the unit prices.

Now, a description will be given of the node 2.

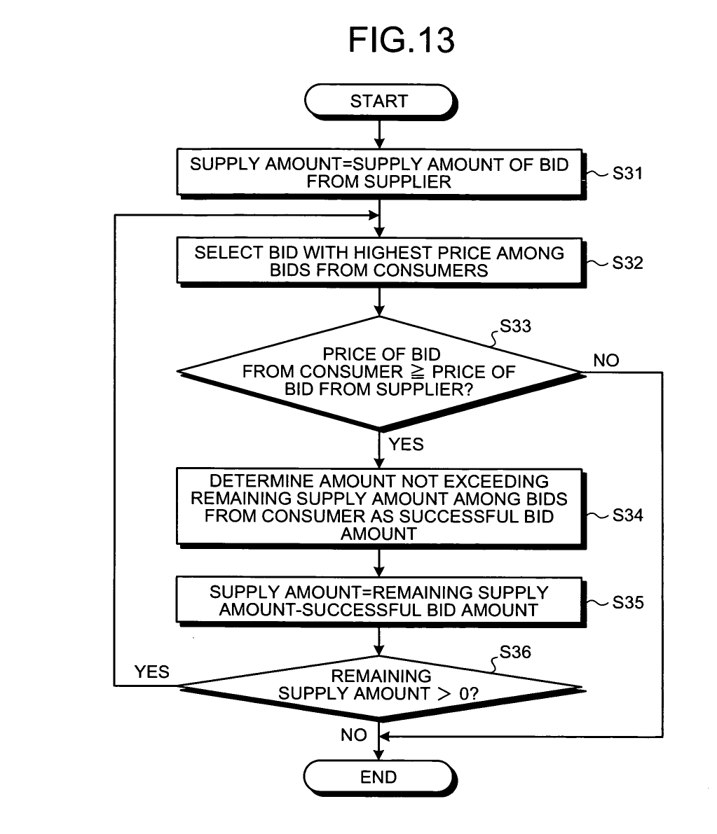

First, as illustrated in FIG. 13, the successful bidder determining unit 106 sets the supply amount to the determined supply amount of the supplier, i.e., the supply amount of the supplier included in the bid information (step S31).

The successful bidder determining unit 106 selects the bid with the highest price from the bid information from the consumers of the resource (step S32). In the case of FIG. 11, the radar information displaying AP 45 is selected.

The successful bidder determining unit 106 determines whether the bid price from the consumer is equal to or greater than the bid value from the supplier (step S33). In the case of FIG. 11, because the bid value of the physical resource manager 42, which is the supplier, is ‘1’ and the bid value of the radar information displaying AP 45, which is the consumer, is ‘4’ (step S33: YES), the process proceeds to step S34.

If the bid price from the consumer is smaller than the bid value from the supplier (step S33: NO), the successful bidder determining unit 106 ends the process.

At step S34, the successful bidder determining unit 106 determines the amount not exceeding the remaining supply amount as the successful bid amount. In the case of FIG. 11, because the consumption amount ‘80’ of the radar information displaying AP 45 can be subtracted from the supply amount ‘180’, the consumption amount ‘80’ corresponding to the amount not exceeding the supply amount is determined as the successful bid amount.

Thereafter, the successful bidder determining unit 106 calculates the remaining supply amount, that is, calculates the remaining supply amount by subtracting the successful bid amount from the supply amount (step S35). In the case of FIG. 11, the remaining supply amount ‘100’ is calculated by subtracting the successful bid amount ‘80’ from the supply amount ‘180’.

Thereafter, the successful bidder determining unit 106 determines whether the remaining supply amount is greater than ‘0’ (step S36).

If the remaining supply amount is greater than ‘0’ (step S36: YES), the process returns to step S32. If the remaining supply amount is equal to or smaller than ‘0’ (step S36: NO), the successful bidder determining unit 106 ends the process.

If returning to step S32, the successful bidder determining unit 106 repeats the process from step S32 to step S36 with regard to the bid from the consumers except the successful bidder.

The process from step S31 to step S36 is repeated a predetermined number of times (three times in this case). The process from step S31 to step S36 corresponds to one round.

In the above manner, if there is a plurality of resource consuming programs among a plurality of application programs, the bid managing unit 103 performs a resource allocating process in such a way that the resources are allocated among the resource consuming programs in descending order of bid values.

Now, a description will be given of the case where one consumer and a plurality of suppliers present, such as the case of the sensor information allocation. In the case of the bid managing unit 45b of the radar information displaying AP 45 according to the embodiment, an operation of the successful bidder determining unit 106 may correspond to the case of replacing ‘Supply’ and ‘Consumption’ with each other and replacing ‘High’ and ‘Low’ with each other in FIG. 13.

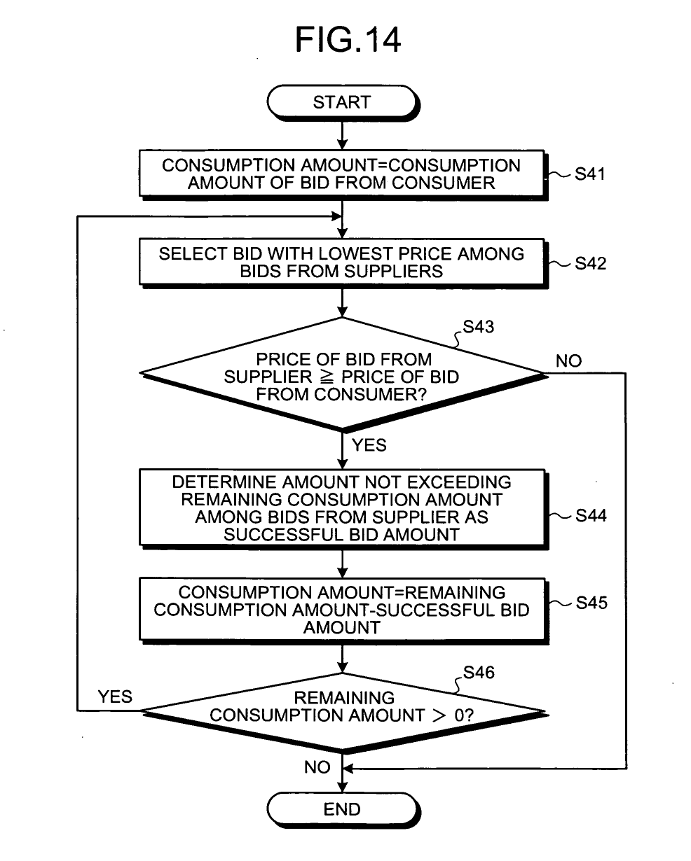

First, as illustrated in FIG. 14, the successful bidder determining unit 106 sets the consumption amount to the determined consumption amount of the consumer, i.e., the consumption amount of the consumer included in the bid information (step S41).

The successful bidder determining unit 106 selects the bid with the lowest price from the bid information from the supplier of the resource (step S42). In the case of FIG. 12, because the radar signal processing AP 43 of the node 2 and the radar signal processing AP 53 of the node 3 have the same bid value ‘37’, one of the two applications is selected by setting the priority beforehand for each of the two applications. For example, the radar signal processing AP 43 is selected based on the priority.

The successful bidder determining unit 106 determines whether the bid price from the supplier is equal to or smaller than the bid value from the consumer (step S43). In the case of FIG. 12, because the bid value of the radar information displaying AP 45 (i.e., the consumer) is ‘1980’ (step S43: YES), the process proceeds to step S44.

If the bid price from the supplier is greater than the bid value from the consumer (step S43: NO), the successful bidder determining unit 106 ends the process.

At step S44, the successful bidder determining unit 106 selects the amount not exceeding the remaining consumption amount as the successful bid amount. In the case of FIG. 12, because the supply amount ‘58’ of the radar information displaying AP 45 can be subtracted from the consumption amount ‘100’, the supply amount ‘58’ corresponding to the amount not exceeding the consumption amount is determined as the successful bid amount.

Thereafter, the successful bidder determining unit 106 calculates the remaining consumption amount (step S45). For example, the successful bidder determining unit 106 calculates the remaining consumption amount by subtracting the successful bid amount from the consumption amount. In the case of FIG. 12, the remaining consumption amount ‘42’ is calculated by subtracting the successful bid amount ‘58’ from the consumption amount ‘100’.

Thereafter, the successful bidder determining unit 106 determines whether the remaining consumption amount is greater than ‘0’ (step S46).

If the remaining consumption amount is greater than ‘0’ (step S46: YES), the process returns to step S42. If the remaining consumption amount is equal to or smaller than ‘0’ (step S46: NO), the successful bidder determining unit 106 ends the process.

If returning to step S42, the successful bidder determining unit 106 repeats the process from step S42 to step S46 with regard to the bid from the supplier except the successful bidder.

The process from step S41 to step S46 is repeated a predetermined number of times (three times in this case). The process from step S41 to step S46 corresponds to one round. The number of repetitions is predetermined as three in the embodiment.

In the above manner, if there is a plurality of resource supplying programs among a plurality of application programs, the bid managing unit 103 performs a resource allocating process in such a way that the resources are allocated among the resource supplying programs in ascending order of bid values.

(d) Round Repetition Managing Unit

The number of process execution times described referring to FIGS. 13 and 14 is counted by the round repetition managing unit 107. The round repetition managing unit 107 controls the aforesaid process for the successful bidder determining unit 106 in order to prevent the process of FIGS. 13 and 14 from being executed more than a predetermined number of times.

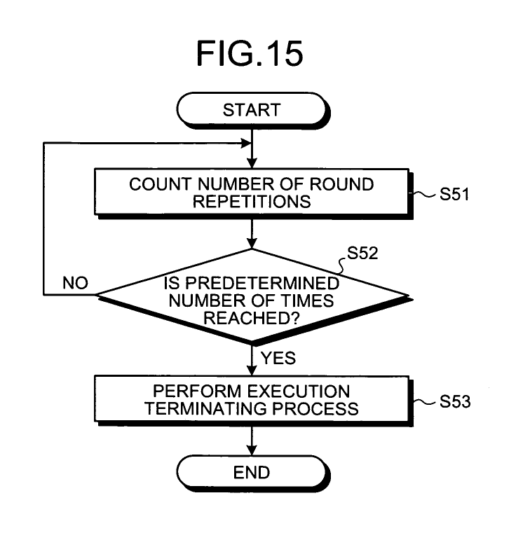

As illustrated in FIG. 15, the round repetition managing unit 107 counts the aforesaid round repetitions (step S51). The round repetition managing unit 107 determines whether the count number of round repetitions becomes a predetermined value, for example, ‘3’ in the embodiment (step S52). If the count number of round repetitions does not reach the predetermined value (step S52: NO), the process returns to step S51. If the count number of round repetitions reaches the predetermined value (step S52: YES), the round repetition managing unit 107 performs an execution terminating process to terminate the process of FIGS. 12 and 13 (step S53). In the execution terminating process, the aforesaid discontinuation notification is output to the resource bidding unit 102 together with or separately from the successful bid information.

In this manner, the round repetition managing unit 107 stores the round count number, and increases the value of the round count number by 1 per each round. If the round count number reaches the upper limit, that is, a predetermined number of times, the round repetition managing unit 107 stops or ends the process so as not to execute any more rounds. The upper limit may be determined by specifying it in the source code of the application by the application creator, or may be given by directly or indirectly specifying through the terminal by the user. The above stop operation guarantees that the bid process is completed within a predetermined time. Also, the information about the round completion/non-completion is notified as additional information when the successful bid result is notified to the processing unit which performed a bid process.

5. Overall Operation of Apparatus

As described above, parameters such as predetermined amounts for the bid value calculating unit 104 in the resource management device are suitably set, thereby making it possible for the radar information displaying AP 45 of the node 2 to operate based on the radar information received from the radar signal processing AP 53 of the node 3.

FIGS. 16 and 17 are tables illustrating the situations of bids and successful bids of the resource management apparatus according to the embodiment, until the number of rounds becomes ‘20’. FIGS. 16 and 17 illustrate data, such as bid values, for 20 consecutive times of rounds. Because the number of round repetitions is ‘3’, rounds 1 to 3 represent the progress and result of the first bidding process and rounds 4 to 6 represent the progress and result of the second bidding process. In this manner, a bidding process is performed for a process unit time in three rounds.

As described above, FIGS. 16 and 17 illustrates an exemplary case of performing the process on the assumption that, in the relationship between the supply and the consumption of the resources, the radar signal processing APs 43 and 53 need the CPU usage rate 135% in order to generate 100% of radar information, the sonar signal processing APs 44 and 54 need the CPU usage rate 90% in order to generate 100% of sonar information, the radar information displaying AP 45 needs the CPU usage rate 60% in order to process 100% of radar information, and the sonar information displaying AP 55 needs the CPU usage rate 35% in order to process 100% of sonar information. Also, the small amounts for increasing or decreasing values in calculations are ‘4’ for the bid value and ‘3’ for the bid amount. In the bid process, the four resources including the sonar information, the radar information, the CPU usage rate of the node 2, and the CPU usage rate of the node 3 are subjected to bids from bidders and the successful bid amount and the successful bid value are determined.

In FIGS. 16 and 17, the resources are suitably allocated in the twentieth and subsequent rounds. As a result of the twentieth round, in the node 2, the radar signal processing AP 43 generates radar information 58% by CPU usage rate 78% and the sonar signal processing AP 44 generates sonar information 37% by CPU usage rate 42%. In the node 3, the radar signal processing AP 53 generates radar information 42% by CPU usage rate 86% and the sonar signal processing AP 54 generates sonar information 63% by CPU usage rate 56%.

Because the radar signal processing APs 43 and 53 need CPU usage rate 135% in order to generate 100% of radar information and the sonar signal processing APs 44 and 54 need CPU usage rate 90% in order to generate 100% of sonar information, the allocation result satisfies the condition of needing CPU usage rate 90%. Also, it satisfies the condition that the radar information displaying AP 45 needs 60% of CPU usage rate and the sonar information displaying AP 55 needs 35% of CPU usage rate. Furthermore, because the radar information displaying AP 45 succeeds in a bid for 100% of radar information and the sonar information displaying AP 55 succeeds in a bid for 100% of sonar information, they obtain display data without problems. In the previous rounds of the twentieth round, the corresponding operations are possible, but sometimes the allocation of the CPU usage rate is insufficient. Thus, there is a possibility that the real-time operation of the entire apparatus may fail to be satisfied. However, because such a state may occur only at the initial bid stage, there is no problem on the whole.

In the embodiment, the radar information is more important than the sonar information. Therefore, the upper limit of the bid value is set such that the signal processing and the information display of the radar device are preferentially performed compared with those of the sonar device. In the above example, the two sensor information displaying APs differ from each other in terms of the upper limit of the purchase price, and each sensor information displaying AP operates within the range of the upper limit by purchasing the resource consumed by the sensor information displaying AP itself. Also, if the upper limit is set to vary depending on situations, the importance of each application can be changed depending on the situations.

Also, because the bid value of the CPU usage rate of the node 3 is lower than the price of the CPU usage rate of the node 2, which is successfully bidden by the radar information displaying AP 45, the radar information processing AP of the node 3 is lower than the radar information processing AP of the node 2 in terms of the bid value (e.g., sale price) as the resource of the radar information. Accordingly, the radar information displaying AP 45 purchases the radar information from the radar signal processing AP 53 of the node 3, and thus the radar signal processing AP 53 of the node 3 is operating.

In addition, because the final bid value memory unit 105 is installed in the resource bidding unit 102, the bid value is calculated based on the bid result of the previous round for the bid process in the next process unit time, thus preventing a long time from being taken to reach a suitable state.

That is, because it is insufficient to only stop the bid process, a plurality of rounds are executed as described above. This is to gradually improve the resource allocation efficiency. However, a small number of rounds may fail to provide sufficient improvement. In such a case, allocation of a resource in the bid for each process unit time is inefficient, thus failing to provide a resource allocation that properly considering the importance of signal processing in the aspect. If there is no final bid value memory unit, the bid values of the supplier and the consumer starts from ‘0’ in each process unit time, thus necessitating a large number of rounds (in the above case, 20 rounds) in order to reach the suitable allocation state. Therefore, as described above, in the embodiment, the bid value of the previous round is stored in the final bid value memory unit 105 in order to reach the suitable allocation state through certain number of periods, such as four process unit time periods, even when the round repetition managing unit 107 stops rounds at the fifth round in order to complete the bid within a predetermined time.

In the embodiment, the round stop condition is the number of repetitions. Alternatively, the round repetition managing unit 107 may discontinue the round at a predetermined time by measuring the round execution time instead of counting the number of round repetitions.

The predetermined time may be determined by specifying it in the source code of the application by the application creator, or may be given by directly or indirectly specifying through the terminal by the user. For example, as a round stop method based on time measurement, a time function of the OS is used to set the time in the initial round and the lapse of the set time is notified to discontinue the round.

Also, as another possible method, a real-time clock of the OS is read at the initial round to record the same in the round repetition managing unit 107, and the difference between the current time and the recorded time is calculated at each round to determine the lapse of a predetermined time.

Although it has been described in the embodiment that the sensor information system 1 includes two nodes 2 and 3, the sensor information system 1 may include three or more nodes. Also, although it has been described that the radar device I/F 25 and the sonar device I/F 35 outputting sensor signals are connected respectively to the node 2 and the node 3, a plurality of sensor signal outputting devices may be connected to one node. That is, some of nodes may not be connected to the sensor signal outputting devices, or a plurality of the sensor signal outputting devices may be connected to the same node.

Although it has been described in the embodiment that two CPUs are installed in each node, one CPU or three or more CPUs may be installed in each node. Also, one or more CPUs may be connected to other circuits through the internal bus of each node.

Although it has been described in the embodiment that the final bid value memory unit 105 is installed to use the final successful bid value for the unit time of the previous round as the first bid value for the next unit time, the final bid value memory unit 105 may be eliminated to perform a bid from the initial value of each round, if allowing a long time to be taken to reach the suitable state.

In the embodiment, the method of calculating the data price from the CPU price that is adjusted based on the size of the CPU usage rate is used. Alternatively, a method of performing a data size-based adjustment on the data price may be used to allocate a resource preferentially to the producer that generates more data by consuming a more CPU usage rate.

The adjusting method based on the size of the CPU usage rate used in the embodiment is superior in terms of the capability of performing the adjustment using a unified constant regardless of running applications.

The adjusting method used in the embodiment enables some specific node to be preferentially used or not to be used by increasing or decreasing the integer for adjusting the CPU price of the node.

According to the embodiment, the bid price of the supply data is adjusted to be increased if the CPU usage rate to be consumed is small.

Thus, the producer generating more data by consuming more CPU usage rate can bid for the data market at a lower bid price than the producer generating less data by consuming smaller CPU usage rate. Therefore, if the process can be performed only by a small number of producers generating more data by consuming more CPU usage rate, the process is not distributed to the producers generating less data by consuming smaller CPU usage rate, so that a small number of the producers may win a bid for data and process the data. Accordingly, the use of the embodiment makes it possible to suppress the process distribution to excessively many nodes.

The resource management program executed by the resource management apparatus according to the embodiment may be written and provided in an installable or executable format in a computer-readable recording medium such as CD-ROM (Compact Dish Read Only Memory), Flexible Disk (FD), CD-R (Compact Disk Recordable), and DVD (Digital Versatile Disk).

Also, the resource management program according to the embodiment may also be installed and provided in a computer-readable recording medium such as ROM.

The resource management program executed by the resource management apparatus according to the embodiment includes a module including the aforesaid respective units (i.e., the resource bidding unit, the bid managing unit, etc.). Thus, in an actual hardware configuration, a CPU (i.e., a processor) reads the resource management program from the recording medium and executes the same, so that the respective units are loaded and created on the main memory device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A resource management apparatus for determining allocation of a resource to be consumed or supplied by each of a plurality of applications within a predetermined unit time in a bidding process, the apparatus comprising:
a bid value calculating unit configured to calculate a bid value representing a hypothetical price of the resource;
an adjusting unit configured to adjust the bid value supplied by an application, which has a smaller resource consumption amount than another application, to be greater than the bid value of the another application; and
a bid managing unit configured to allocate the resource to each of the plurality of applications taking the adjusted bid value into account.

2. The apparatus according to claim 1, wherein the adjusting unit adjusts the bid value by adding a value to the bid value, the greater adding value being set for the application having the smaller resource consumption amount.

3. The apparatus according to claim 1, wherein the adjusting unit adjusts the bid value by adding an output value to the bid value, the output value being output by inputting the consumption amount to a predetermined function that outputs a smaller value for the greater consumption amount.

4. The apparatus according to claim 3, wherein the function outputs the value that is inversely proportional to the input consumption amount.

5. The apparatus according to claim 1, wherein the resource is a processor and
the adjusting unit adjusts the bid value, which corresponds to information generated by means of the processor and is supplied from the application that has the smaller resource consumption amount than the another application, to be greater than the bid value of the another application.

6. A computer program product having a computer-readable medium stored thereon instructions for managing a resource in a bidding process that allocates the resource to be consumed or supplied by each of a plurality of applications within a predetermined unit time, the instructions, when executed by a computer, causes the computer to:
calculate a bid value representing a hypothetical price of the resource;
adjust the bid value supplied by an application, which has a smaller resource consumption amount than another application, to be greater than the bid value of the another application; and
allocate the resource to each of the plurality of applications taking the adjusted bid value into account.
